(19) United States
(12) Patent Application Publication
(10) Pub. No.: US 2026/0115510 A1
(43) Pub. Date: Apr. 30, 2026

(54) FIRE EXTINGUISHING SYSTEM FOR VEHICLE

(71) Applicants: HYUNDAI MOTOR COMPANY, SEOUL (KR); KIA CORPORATION, SEOUL (KR)

(72) Inventor: Hyeon Gi Shin, Hwaseong-si (KR)

(73) Assignees: HYUNDAI MOTOR COMPANY, SEOUL (KR); KIA CORPORATION, SEOUL (KR)

(21) Appl. No.: 19/045,185

(22) Filed: Feb. 4, 2025

(30) Foreign Application Priority Data
Oct. 28, 2024 (KR) 10-2024-0148248

(51) Int. Cl. A62C 3/07; A62C 3/06; A62C 3/16

(52) U.S. Cl. CPC A62C 3/07; A62C 3/06; A62C 3/16

(57) ABSTRACT

A fire extinguishing system for a vehicle includes a suction-discharge pipe provided in a fire response space and equipped with a nozzle for spraying a fire-extinguishing fluid, a smoke detection pipe connected to the suction-discharge pipe through a valve to selectively communicate with the suction-discharge pipe, an air compressor that applies suction pressure to the smoke detection pipe, a smoke detector that detects smoke suctioned by the suction pressure through the smoke detection pipe, a controller that outputs, in a case where smoke is detected through the smoke detector, a control signal to supply the fire extinguishing fluid to the suction-discharge pipe so that the fire extinguishing fluid is sprayed through the nozzle into the fire response space, and a fire extinguishing fluid supply device provided to supply the fire extinguishing fluid to the suction-discharge pipe according to the control signal output from the controller.

### CROSS REFERENCE TO RELATED APPLICATIONS

This application claims, under 35 U.S.C. §119(a), the benefit of priority to Korean Patent Application No. 10-2024-0148248 filed on October 28, 2024, the entire contents of which are incorporated herein by reference.

### BACKGROUND

### a. Technical Field

The present disclosure relates to a fire extinguishing system for a vehicle capable of accurately detecting fire occurring in the vehicle and quickly and automatically extinguishing the fire.

### b. Background Art

In general, vehicles use flammable fuel, have multiple heat sources, and have various electrical wires tangled together, so there is a constant risk of fire.

For example, since a high-temperature engine and various electrical devices are provided in an engine compartment of a vehicle, the engine and electrical devices may be damaged or malfunction due to a collision accident or the like thereby resulting in fire. Further, in the engine compartment, there is a risk of fire during vehicle driving due to engine overheating or exhaust gas post-treatment.

In order to prepare for such a risk, a fire extinguisher is generally known. However, in a case where a driver fails to use the fire extinguisher in time, it is difficult to extinguish the fire, so that the fire may spread throughout the vehicle.

Moreover, in the case of a public transportation vehicle such as a bus in which many passengers ride, fire prevention management is essential for passenger safety because fire occurring in such a public transportation vehicle may lead to a large-scale disaster.

In addition, since the driver is inside the vehicle during driving, even in a case where fire occurs in the engine compartment, the fire may not be noticed until a large amount of smoke is generated. In particular, since an engine compartment of a bus is located at the rear of the vehicle, unlike a passenger car, it is more difficult for the driver to notice the engine compartment fire.

Therefore, in a case where the driver fails to quickly take action to extinguish the fire in an early stage, the fire may spread and the entire vehicle may burn, which may increase the risk of casualties. Even in a case where the driver or passengers inside the vehicle are aware of the fire, it is difficult to extinguish the fire using only the small fire extinguisher provided in the vehicle.

Recently, as the use of eco-friendly vehicles such as electric vehicles and fuel cell vehicles increases, the risk of fire in batteries or high-voltage electrical wires due to external impact or internal short circuits is increasing.

In particular, in the case of a large electric bus (xEV), a PE (Power Electric) compartment where various electric devices and electrical wires are provided is located at the rear of the vehicle instead of an engine compartment. FIG. 1 is a diagram briefly showing a PE compartment 2 of a vehicle 1 such as an electric bus.

In the PE compartment 2, electric components (PE components) and electrical wires are provided in a complex manner. Although not shown in detail in the drawing, a motor for driving a vehicle, an LDC (Low voltage DC-DC Converter) that is a power conversion system, low voltage/high voltage wires, a water heater, a junction box, an air compressor, a cooling module, etc. are provided therein.

As a result of analysis of a fire occurrence probability in the devices or components provided in the PE compartment 2, it is known that the fire occurrence probability is the highest in the low-voltage/high-voltage wires.

As a result of a fire simulation test conducted by increasing electric current by 100A using the low-voltage/high-voltage wires, smoke was generated at a part where a connector and a cable were in contact, and it was found that a gas (smoke) detector was suitable as a fire detection sensor in the PE compartment 2.

Using a flame detector as a fire detection sensor is the most accurate method, but the flame detector cannot detect fire in its early stage, and can detect the fire only when the fire spreads to a certain extent.

Since a temperature detector can only detect a rise in temperature at its installation location, it is not possible to cover the entire space of the PE compartment for fire detection with a small number of temperature detectors, and in a case where a large number of temperature detectors are provided in the PE compartment, the layout becomes very complicated.

A smoke detector may be used as a fire detection sensor in the PE compartment 2, but the biggest problem when using the gas (smoke) detector is the presence of a cooling fan (electric fan). In a case where fire occurs while the cooling fan is in operation, smoke may not move to the smoke detector due to the cooling fan.

Among devices that make up a cooling module, the cooling fan is a device that supplies air to a radiator. The cooling fan is generally provided on a rear side of the vehicle 1 as shown in FIG. 1, and suctions in outside air and supplies the same to the PE compartment 2.

Here, forced convection of air occurs inside the PE compartment 2 by the air supplied by the cooling fan, and as the air moves strongly in one direction, the smoke generated here also moves.

In this case, the smoke detector should be able to detect the fire by detecting smoke when fire breaks out. However, in a case where fire occurs at the time when the cooling fan is operating, the smoke is more likely to not reach the smoke detector due to the air blown by the cooling fan, and thus, the fire may not be detected by the smoke detector.

The above information disclosed in this Background section is only for enhancement of understanding of the background of the disclosure and therefore it may contain information that does not form the prior art that is already known in this country to those skilled in the art.

### SUMMARY

The present disclosure has been made in an effort to solve the-described problems associated with prior art, and an object of the present disclosure is to provide a fire extinguishing system for a vehicle capable of accurately detecting fire occurring in the vehicle and quickly and automatically extinguishing the fire.

In one aspect, the present disclosure provides a fire extinguishing system for a vehicle including a smoke suctioning and fire extinguishing fluid discharge pipe that is provided in a fire response space and is equipped with a nozzle for spraying a fire-extinguishing fluid, a smoke detection pipe connected to the smoke suctioning and fire extinguishing fluid discharge pipe through a valve to selectively communicate with the smoke suctioning and fire extinguishing fluid discharge pipe, an air compressor configured to apply suction pressure to the smoke detection pipe, a smoke detector that detects smoke suctioned through the nozzle by the suction pressure of the air compressor acting on the smoke suctioning and extinguishing fluid discharge pipe through the smoke detection pipe, a controller that outputs, in a case where smoke is detected through the smoke detector, a control signal to supply the fire extinguishing fluid to the smoke suctioning and fire extinguishing fluid discharge pipe so that the fire extinguishing fluid is sprayed through the nozzle into the fire response space, and a fire extinguishing fluid supply device provided to supply the fire extinguishing fluid to the smoke suctioning and fire extinguishing fluid discharge pipe according to the control signal output from the controller.

In an embodiment, a plurality of the fire response spaces may be provided in the vehicle, and the smoke suctioning and fire extinguishing fluid discharge pipe may be provided in each of the fire response spaces.

In another embodiment, the plurality of fire response spaces may include one or both of a PE compartment in which power electric (PE) parts are provided and a battery compartment in which a battery is provided.

In still another embodiment, the fire response space may include a PE compartment in which power electric (PE) parts are provided, and a battery compartment in which a battery is provided, and the smoke suctioning and fire extinguishing fluid discharge pipe for spraying the fire extinguishing fluid to the power electronic parts or the battery through the nozzle may be provided in each of the PE compartment and the battery compartment.

In yet another embodiment, in a case where the suction pressure of the air compressor is applied to the smoke suctioning and fire extinguishing fluid discharge pipe provided in the PE compartment and the smoke suctioning and fire extinguishing fluid discharge pipe provided in the battery compartment through the smoke detection pipe, the controller may control the air compressor at a speed corresponding to a speed of a cooling fan provided in the PE compartment or a speed of a cooling fan provided in the battery compartment.

In still yet another embodiment, the controller may determine the speed of the air compressor as a larger value between the speed of the cooling fan provided in the PE compartment and the speed of the cooling fan provided in the battery compartment, and may determine the speed of the air compressor as a larger value as the speed of the cooling fan becomes higher.

In a further embodiment, a fire extinguishing fluid supply pipe that supplies the fire extinguishing fluid from the fire extinguishing fluid supply device may be extended to the PE compartment and the battery compartment, and the smoke suctioning and fire extinguishing fluid discharge pipe may be connected to the fire extinguishing fluid supply pipe through the valve to selectively communicate with the fire extinguishing fluid supply pipe.

In another further embodiment, in the middle of the fire extinguishing fluid supply pipe, the PE compartment-side smoke suctioning and fire extinguishing fluid discharge pipe and the PE compartment-side smoke detection pipe may be connected through a first valve in the form of a 4-way valve whose opening state is controlled by the controller, which is one of the valves, and an end of the fire extinguishing fluid supply pipe, the battery compartment-side smoke suctioning and fire extinguishing fluid discharge pipe, and the battery compartment-side smoke detection pipe may be connected through a second valve in the form of a 3-way valve whose opening state is controlled by the controller, which is one of the valves.

In still another further embodiment, the PE compartment-side smoke detection pipe connected to the PE compartment-side smoke suctioning and fire extinguishing fluid discharge pipe provided in the PE compartment through the valve, and the battery compartment-side smoke detection pipe connected to the battery compartment-side smoke suctioning and fire extinguishing fluid discharge pipe provided in the battery compartment through the valve may be connected through a third valve after passing through the smoke detector, and the PE compartment-side smoke detection pipe, the battery compartment-side smoke detection pipe, and a suction pipe connected to an inlet of the air compressor may be connected through the third valve whose opening state is controlled by the controller.

In yet another further embodiment, the fire extinguishing fluid supply device may include a fire extinguishing fluid tank in which the fire extinguishing fluid is stored, and a pressure transfer plate that is moved by pressure of a working fluid supplied to a pressure chamber of the fire extinguishing fluid tank and pressurizes the fire extinguishing fluid filled in a fire extinguishing fluid chamber of the fire extinguishing fluid tank to discharge the fire extinguishing fluid from the fire extinguishing fluid tank to the fire extinguishing fluid supply pipe.

In still yet another further embodiment, the working fluid may be compressed air supplied by the air compressor.

In a still further embodiment, the PE compartment-side smoke detection pipe connected to the PE compartment-side smoke suctioning and fire extinguishing fluid discharge pipe provided in the PE compartment through the valve, and the battery compartment-side smoke detection pipe connected to the battery compartment-side smoke suctioning and fire extinguishing fluid discharge pipe provided in the battery compartment through the valve may be connected through a third valve after passing through the smoke detector, and the PE compartment-side smoke detection pipe, the battery compartment-side smoke detection pipe, an intake port connected to the atmosphere, and a suction pipe connected to an inlet of the air compressor may be connected through the third valve in the form of a 4-way valve whose opening state is controlled by the controller.

In a yet still further embodiment, a fourth valve in the form of a 3-way valve whose opening state is controlled by the controller, may be provided at a location where an exhaust port branches off in the middle of an air supply pipe connected to the pressure chamber of the fire extinguishing fluid tank to supply compressed air from the air compressor.

In a yet still further embodiment, the nozzle may include a nozzle pipe having a first end portion connected to the smoke suctioning and fire extinguishing fluid discharge pipe and a second end portion through which air or air and smoke inside the fire response space is suctioned or the fire extinguishing fluid is discharged and sprayed, and a filter member provided in the nozzle pipe to remove foreign substances in the air or air and smoke suctioned through the second end portion of the nozzle pipe by the suction pressure of the air compressor.

In a yet still further embodiment, the filter member may include a first filter member that is provided at the second end portion of the nozzle pipe to primarily remove foreign substances, and a second filter member that is provided inside the nozzle pipe and secondarily removes foreign substances passed through the first filter member.

In a yet still further embodiment, the first filter member may be detachably provided at the second end portion of the nozzle pipe, the second filter member may be movably provided in a space between the first end portion and the second end portion inside the nozzle pipe, and the primary and second filter members, in a case where the second filter member is moved by the fire extinguishing fluid passing through the inside of the nozzle pipe and impacts the first filter member in spraying the fire extinguishing fluid, may be provided to be detached together from the nozzle pipe.

In a yet still further embodiment, the second filter member may be a ball-shaped member made of a mesh structure through which the air or air and smoke passes.

### BRIEF DESCRIPTION OF THE FIGURES

The and other features of the present disclosure will be described in detail with reference to certain exemplary embodiments thereof illustrated the accompanying drawings which are given hereinbelow by way of illustration only, and thus are not limitative of the present disclosure, and wherein:

FIG. 1 is a drawing for illustrating occurrence of forced convection of air inside a PE compartment by a cooling fan in a typical electric bus;

FIG. 2 is a block diagram showing a configuration of a fire extinguishing system according to an embodiment of the present disclosure;

FIG. 3 is a drawing showing a state in which a smoke suctioning and fire extinguishing fluid discharge pipe of a fire extinguishing system according to an embodiment of the present disclosure is provided in a PE compartment;

FIG. 4 is a diagram showing a state in which a smoke suctioning and fire extinguishing fluid discharge pipe of a fire extinguishing system according to an embodiment of the present disclosure is provided in a battery compartment;

FIG. 5 is a diagram showing a configuration of a fire extinguishing system according to an embodiment of the present disclosure;

FIG. 6 is a diagram showing a photoelectric smoke detector having a light-emitting element and a light-receiving element according to an embodiment of the present disclosure;

FIG. 7 is a diagram showing a configuration of a nozzle provided in a smoke suctioning and fire extinguishing fluid discharge pipe according to an embodiment of the present disclosure;

FIG. 8 is a diagram showing an operating state of the nozzle in a fire detection mode according to an embodiment of the present disclosure;

FIG. 9 is a diagram showing an operating state of the nozzle when spraying a fire extinguishing fluid according to an embodiment of the present disclosure;

FIG. 10 is a drawing showing an operating state in the fire detection mode of the fire extinguishing system according to the embodiment of the present disclosure;

FIG. 11 is a diagram showing an operating state when fire is detected in a PE compartment of the fire extinguishing system according to the embodiment of the present disclosure;

FIG. 12 is a diagram showing an operating state when fire is detected in a battery compartment of the fire extinguishing system according to the embodiment of the present disclosure;

FIG. 13 is a diagram for illustrating a method of controlling an air compressor by a controller of the fire extinguishing system according to the embodiment of the present disclosure;

FIG. 14 is a diagram for illustrating a method of detecting fire by the controller of the fire extinguishing system according to the embodiment of the present disclosure; and

FIG. 15 is a diagram for illustrating a control state in fire detection of the fire extinguishing system according to the embodiment of the present disclosure.

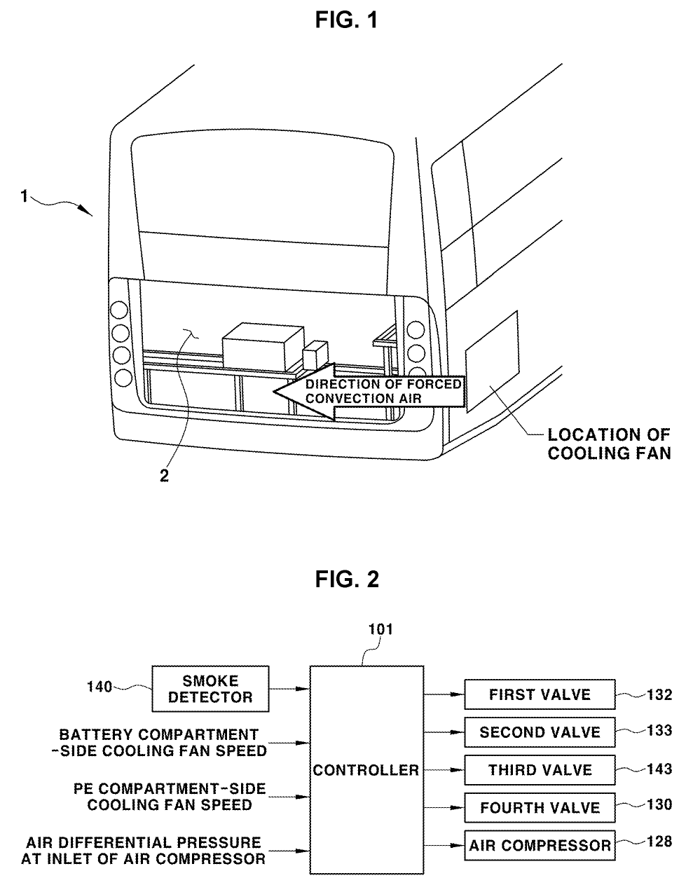

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, embodiments of the present disclosure will be described in detail with reference to the accompanying drawings. Specific structural or functional descriptions presented in the embodiments of the present disclosure are merely exemplified for the purpose of describing embodiments according to the concept of the present disclosure, and embodiments according to the concept of the present disclosure may be implemented in various forms. Furthermore, the present disclosure should not be construed as limited to the embodiments described in this specification, but should be understood to include all modifications, equivalents, or substitutes included in the concept and technical scope of the present disclosure.

It will be understood that, although the terms “first”, “second”, etc. may be used herein to describe various elements, these elements should not be limited by these terms. These terms are only used to distinguish one element from another. For example, a first element may be termed a second element, and, similarly, a second element may be termed a first element, without departing from the scope of the exemplary embodiments of the present disclosure.

In addition, it will be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other expressions used to describe the relationship between elements should be interpreted in a similar manner (for example, “between” and “directly between”, “adjacent” and “directly adjacent”, etc.).

Wherever possible, the same reference numbers will be used throughout the drawings to refer to the same or like parts. The terminology used herein is for the purpose of describing particular embodiments only and is not intended to limit exemplary embodiments of the disclosure. As used herein, the singular forms “a”, “an”, and “the” are intended to include the plural forms as well, unless the context clearly indicates otherwise. It will be further understood that the terms “comprise”, “include”, and “have” used herein specify the presence of stated components, steps, operations, and/or elements, but do not preclude the presence or addition of one or more other components, steps, operations, and/or elements.

The present disclosure relates to a fire extinguishing system for a vehicle, capable of accurately detecting fire occurring in the vehicle and quickly and automatically extinguishing the fire. Here, the vehicle may be a large vehicle, for example, a bus.

More specifically, the vehicle may be a vehicle that runs by driving a motor by battery power, for example, an electric vehicle (xEV) such as a hydrogen electric bus (fuel cell bus) or a battery electric bus.

A fire extinguishing system according to an embodiment of the present disclosure may be a fire extinguishing system capable of detecting and extinguishing fire occurring in a PE compartment located at the rear of a vehicle, or may be a fire extinguishing system capable of detecting and extinguishing fire occurring in a battery compartment, for example, a battery compartment provided on an upper side of a vehicle roof.

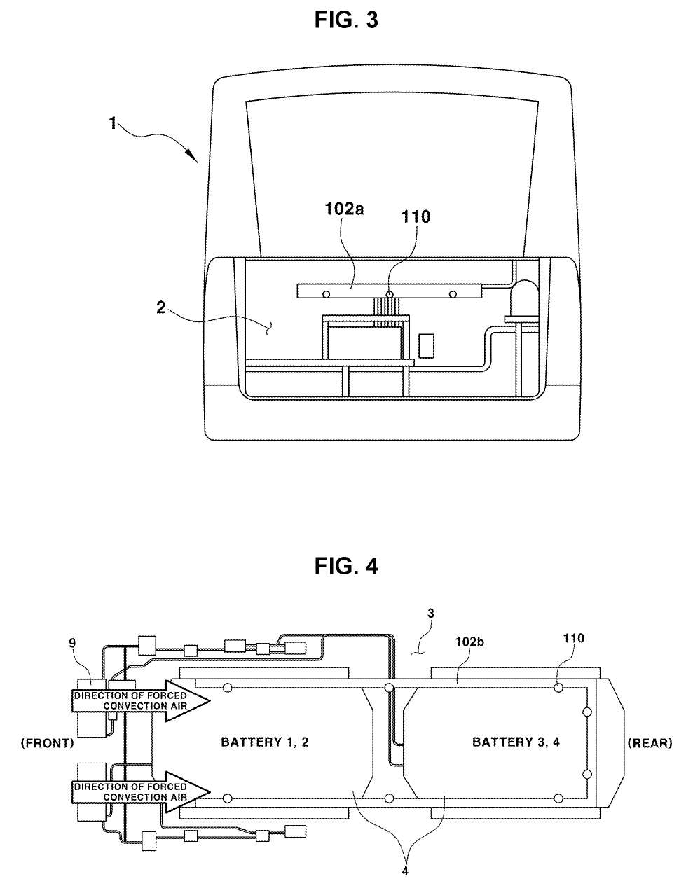

FIG. 2 is a block diagram showing a configuration of a fire extinguishing system according to an embodiment of the present disclosure, and FIG. 3 is a drawing showing a state in which a smoke suctioning and fire extinguishing fluid discharge pipe of the fire extinguishing system according to the embodiment of the present disclosure is provided within a PE compartment.

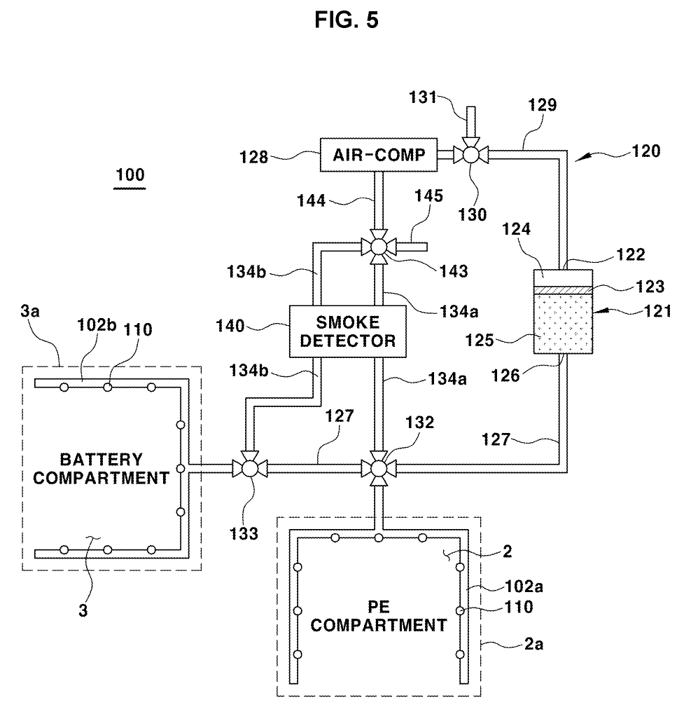

The fire extinguishing system according to the present disclosure may be configured in a power electric (PE) compartment 2 (fire response space) at the rear of a vehicle 1, and a smoke suctioning and fire extinguishing fluid discharge pipe 102a is provided in the PE compartment 2. The smoke suctioning and fire extinguishing fluid discharge pipe 102a may be provided in an upper structure 2a (in FIG. 5) inside the PE compartment 2.

The smoke suctioning and fire extinguishing fluid discharge pipe 102a is a member that suctions smoke for fire detection within the PE compartment 2 and supplies, sprays, and discharges a fire extinguishing fluid for fire suppression.

In the present embodiment, the smoke suctioning and fire extinguishing fluid discharge pipe 102a may be provided in an approximately U-shape (see FIG. 5) in an upper space within the PE compartment 2 to spray the fire extinguishing fluid downwardly toward the electric components (PE components) within the PE compartment 2.

In the present embodiment, the smoke suctioning and fire extinguishing fluid discharge pipe 102a may have a plurality of nozzles 110, and may forcibly suction smoke generated by fire in the PE compartment 2 together with air through each nozzle 110.

In the present disclosure, in a case where fire in the PE compartment 2 is detected using a smoke detector 140 from smoke forcibly suctioned through the smoke suctioning and fire extinguishing fluid discharge pipe 102a, the fire extinguishing fluid is supplied through the smoke suctioning and fire extinguishing fluid discharge pipe 102a so that the fire extinguishing fluid is sprayed and discharged through the nozzle 110 in the PE compartment 2.

FIG. 4 is a diagram showing a state in which a smoke suctioning and fire extinguishing fluid discharge pipe of a fire extinguishing system according to an embodiment of the present disclosure is provided in a battery compartment. The fire extinguishing system according to the present disclosure may be configured in a battery compartment 3 (fire response space) on an upper side of a vehicle roof, and a smoke suctioning and fire extinguishing fluid discharge pipe 102b may be provided in the battery compartment 3.

Referring to FIG. 4, it can be seen that a battery pack assembly 4 is provided at front and rear positions in a front-back direction of the vehicle, and the smoke suctioning and fire extinguishing fluid discharge pipe 102b having an approximately U-shape is provided together with heat management components such as a cooling fan 9 of a cooling module.

The smoke suctioning and fire extinguishing fluid discharge pipe 102b suctions smoke to detect fire in the battery compartment 3, and supplies, sprays, and discharges the fire extinguishing fluid to suppress the fire. The smoke suctioning and fire extinguishing fluid discharge pipe 102b may be provided in an upper space within the battery compartment 3.

The smoke suctioning and fire extinguishing fluid discharge pipe 102b may be provided in the approximately U-shape in the upper space within the battery compartment 3 so as to spray the fire extinguishing fluid downwardly toward the battery pack assembly 4 in the battery compartment 3.

For example, the smoke suctioning and fire extinguishing fluid discharge pipe 102b may be provided in a structure 3a (in FIG. 5) such as a battery cover located in the upper space within the battery compartment 3.

In an embodiment of the present disclosure, the smoke suctioning and fire extinguishing fluid discharge pipe 102b in the battery compartment 3 may have a plurality of nozzles 110 for smoke suction, and may suction smoke generated in the battery compartment 3 when a fire breaks out together with air through each nozzle 110.

In a case where the fire in the battery compartment 3 is detected using the smoke detector 140 from the smoke suctioned through the smoke suctioning and fire extinguishing fluid discharge pipe 102b, the fire extinguishing fluid is supplied through the smoke suctioning and fire extinguishing fluid discharge pipe 102b so that the fire extinguishing fluid can be sprayed and discharged through each nozzle 110 within the battery compartment 3. In the case of the battery compartment 3, a large amount of flammable gas is generated and released when fire occurs, and a smoke detector is suitable as a sensor for early detection of the fire.

In the case of the battery compartment 3, the cooling fan 9 of the cooling module is mounted at the front of the vehicle 1 to generate forced convection of air and suctions outside air from the front of the vehicle 1 and supplies the air to the rear. The direction of forced convection is a direction in which the air moves from the front to the rear as shown in FIG. 4.

When the cooling fan operates, since the forced convection of air occurs within the battery compartment 3, in a case where the smoke detector 140 (in FIG. 2) for fire detection is provided within the battery compartment 3, smoke from fire may not flow to the smoke detector 140 due to the forced convection of air by the cooling fan, and thus, the smoke detector 140 may not detect the occurrence of the fire in time.

Accordingly, as in the PE compartment 2, the smoke suctioning and fire extinguishing fluid discharge pipe 102b is provided in the battery compartment 3, so that smoke generated by fire is forcibly suctioned into the smoke suctioning and fire extinguishing fluid discharge pipe 102b and then detected by the smoke detector 140 on a pipe (smoke detection pipe) connected to the smoke suctioning and fire extinguishing fluid discharge pipe, thereby enabling smoke to be accurately detected at the time of fire in the space, regardless of the operation of the cooling fan 9 or the occurrence of forced convection.

The smoke detector 140 may be provided in a location that is not affected by forced convection by the cooling fan 9, and for example, may be provided outside the PE compartment 2 and the battery compartment 3, not inside the PE compartment 2 and battery compartment 3.

In the present disclosure, there is no difference in the operating state, function, or use of the smoke suctioning and fire extinguishing fluid discharge pipe 102a or 102b between a case where it is provided in the PE compartment 2 and a case where it is provided in the battery compartment 3. That is, the smoke suctioning and fire extinguishing fluid discharge pipe 102a or 102b has the same function and operation in a case where it is provided in the PE compartment 2 and in a case where it is provided in the battery compartment 3.

FIG. 5 is a diagram showing configuration of a fire extinguishing system according to an embodiment of the present disclosure, and shows an example in which the PE compartment 2 and the battery compartment 3 are set as a fire response space for suppressing fire in the vehicle 1. In the present disclosure, the fire response space may include one or two of the PE compartment and the battery compartment.

More specifically, in the present disclosure, the smoke suctioning and fire extinguishing fluid discharge pipe may be provided in the PE compartment 2 or the battery compartment 3, or may be provided in both the PE compartment 2 and the battery compartment 3.

In the embodiment of FIG. 5, one PE compartment 2 and one battery compartment 3 are set as the fire response spaces of the vehicle where an extinguishing fluid is sprayed by the fire extinguishing system 100, but fire response spaces other than the PE compartment and the battery compartment may be set within the vehicle, and a plurality of PE compartments or a plurality of battery compartments may be set as the fire response spaces.

In this way, the smoke suctioning and fire extinguishing fluid discharge pipe 102a or 102b may be provided in the fire response space set in advance in the vehicle 1 to extinguish fire. To this end, as described above, one or more fire response spaces may be provided.

As shown in FIG. 5, the smoke suctioning and fire extinguishing fluid discharge pipe 102a or 102b may be provided in an approximately U-shape on a PE compartment cover 2a or a battery compartment cover 3a, and a nozzle 110 that sprays a fire extinguishing fluid may be provided at preset intervals in the length direction.

In the smoke suctioning and fire extinguishing fluid discharge pipe 102a or 102b, the nozzles 110 may be provided at regular intervals in the length direction, and the smoke suctioning and fire extinguishing fluid discharge pipe 102a or 102b and the nozzles 110 may be provided in the upper space within the PE compartment 2 and the battery compartment 3 so as to spray the fire extinguishing fluid downwardly toward the electrical components (PE components) or battery pack assembly where fire has occurred.

A fire extinguishing fluid supply pipe 127 is connected to the smoke suctioning and fire extinguishing fluid discharge pipes 102a and 102b provided in the respective fire response spaces of the PE compartment 2 and the battery compartment 3. Further, the fire extinguishing fluid supply pipe 127 is connected to a fire extinguishing fluid supply device 120.

That is, the fire extinguishing fluid supply pipe 127 is extended to each fire response space of the PE compartment 2 and the battery compartment 3 to supply the fire extinguishing fluid from the fire extinguishing fluid supply device 120, and is connected to the smoke suctioning and fire extinguishing fluid discharge pipes 102a and 102b.

In addition, smoke detection pipes 134a and 134b are branched at separate locations of the fire extinguishing fluid supply pipe 127. Each of the smoke detection pipes 134a and 134b is extended to pass through the smoke detector 140. The two smoke detection pipes 134a and 134b that pass through the smoke detector 140 are combined into one pipe and then connected to an air compressor 128.

A multi-way valve is provided at each location where the smoke detection pipes 134a and 134b are branched from the fire extinguishing fluid supply pipe 127. For example, a 3-way valve or a 4-way valve may be provided according to the number of branches.

For example, as shown in FIG. 5, at a location where there are four branches of the fire extinguishing fluid supply pipe 127 connected from the fire extinguishing fluid supply device 120, the PE compartment-side smoke suctioning and fire extinguishing fluid discharge pipe 102a, the PE compartment-side smoke detection pipe 134a connected to the smoke detector 140, and the battery compartment-side smoke suctioning and fire extinguishing fluid discharge pipe 102b (i.e., connected to a second valve to be described later), a multi-way valve 132 (referred to hereinafter as a “first valve”) in the form of the 4-way valve is provided.

In addition, at a location where there are three branches of the fire extinguishing fluid supply pipe 127 connected from the first valve 132, the battery compartment-side smoke suctioning and fire extinguishing fluid discharge pipe 102b, and the battery compartment-side smoke detection pipe 134b connected to the smoke detector 140, a multi-way valve 133 (referred to hereinafter as the “second valve”) in the form of the 3-way valve is provided.

Further, at a location where the smoke detection pipes 134a and 134b of the two fire response spaces that passes through the smoke detector 140 are combined at an exit side of the smoke detector 140, that is, on a rear end side of the smoke detector 140, an intake port 145 connected to the atmosphere is branched.

At the location where the smoke detection pipes 134a and 134b are combined, since there are four branches including a suction pipe 144 connected to an inlet of the air compressor 128, a multi-way valve 143 (referred to hereinafter as a “third valve”) in the form of a 4-way valve is provided.

That is, on the rear end side of the smoke detector 140, the smoke detection pipes 134a and 134b extended from the fire response spaces and the suction pipe 144 connected to the inlet of the air compressor 128 are connected via the third valve 143, and the intake port 145 is additionally connected to the third valve 143 so as to be selectively connected to the suction pipe 144.

Further, in the embodiment of the present disclosure, the fire extinguishing fluid supply device 120 is configured to include a fire extinguishing fluid tank 121 in which the fire extinguishing fluid is stored, and a pressure transfer plate 123 that pressurizes the fire extinguishing fluid by pressure of a working fluid supplied to a pressure chamber 124 of the fire extinguishing fluid tank 121 to discharge the fire extinguishing fluid to the fire extinguishing fluid supply pipe 127 in a high-pressure state.

The pressure transfer plate 123 is provided transversely in an internal space of the fire extinguishing fluid tank 121 to divide the internal space of the fire extinguishing fluid tank 121 into front and rear sections. In particular, the pressure transfer plate 123 is provided to move forward and backward in a state of being transversely provided in the internal space of the fire extinguishing fluid tank 121.

In the internal space of the fire extinguishing fluid tank 121, among two spaces divided by the pressure transfer plate 123, that is, a space in front of the pressure transfer plate 123 is a fire extinguishing fluid chamber 125 where the fire extinguishing fluid is filled, and a space behind the pressure transfer plate 123 is the pressure chamber 124 where the working fluid is supplied and the pressure of the working fluid is applied.

Here, the working fluid may be compressed air supplied by the air compressor 128. To this end, an air inlet port 122 connected to the pressure chamber 124 is provided at a rear end portion of the fire extinguishing fluid tank 121 where the pressure chamber 124 is located at the rear of the pressure transfer plate 123, and an air supply pipe 129 through which compressed air is supplied from the air compressor 128 is connected to the air inlet port 122.

The air supply pipe 129 is connected between an outlet (not shown) through which compressed air is discharged from the air compressor 128 and the air inlet port 122 of the fire extinguishing fluid tank 121. A multi-way valve of a 3-way valve type (referred to hereinafter as a “fourth valve”) is provided in the middle of the air supply pipe 129, and an exhaust port 131 may be connected to the fourth valve 130 to be selectively connected to the air supply pipe 129.

The fire extinguishing fluid supply pipe 127 is connected to a fire extinguishing fluid outlet port 126 provided in the fire extinguishing fluid chamber 125 in front of the pressure transfer plate 123 in the fire extinguishing fluid tank 121. The fire extinguishing fluid supply pipe 127 is connected to the fire response spaces, that is, the PE compartment 2 and the battery compartment 3.

Specifically, the fire extinguishing fluid supply pipe 127 is connected to the smoke suctioning and fire extinguishing fluid discharge pipes 102a and 102b provided in the fire response spaces, that is, the PE compartment 2 and the battery compartment 3 from the fire extinguishing fluid outlet port 126 of the fire extinguishing fluid tank 121.

Accordingly, the fire extinguishing fluid in the fire extinguishing fluid tank 121 may be discharged through the fire extinguishing fluid outlet port 126 to the fire extinguishing fluid supply pipe 127, and then, may move along the fire extinguishing fluid supply pipe 127 to be supplied to the smoke suctioning and fire extinguishing fluid discharge pipe 102a or 102b in each fire response space (PE compartment and battery compartment).

Then, the fire extinguishing fluid supplied to the smoke suctioning and fire extinguishing fluid discharge pipe 102a or 102b may be sprayed into the interior of the fire response space through the nozzle 110 provided at each location, thereby making it possible to extinguish fire using the fire extinguishing fluid.

In the present disclosure, the air compressor 128 is a component that provides suction pressure for fire detection to the smoke suctioning and fire extinguishing fluid discharge pipes 102a and 102b, and is a component that supplies the working fluid to the fire extinguishing fluid tank 121 of the fire extinguishing fluid supply device. The operations of the air compressor 128, the first valve 132, the second valve 133, the third valve 143, and the fourth valve 130 are controlled by a control signal output from a controller 101 (see FIG. 2).

In the present disclosure, in a case where it is determined that fire occurs in a fire response space from an electrical signal input from the smoke detector 140, the controller 101 outputs a control signal for fire suppression. Accordingly, the operations of the air compressor 128 and the first to fourth valves (132, 133, 143, 130) are controlled to extinguish the fire occurring in the fire response space according to the control signal.

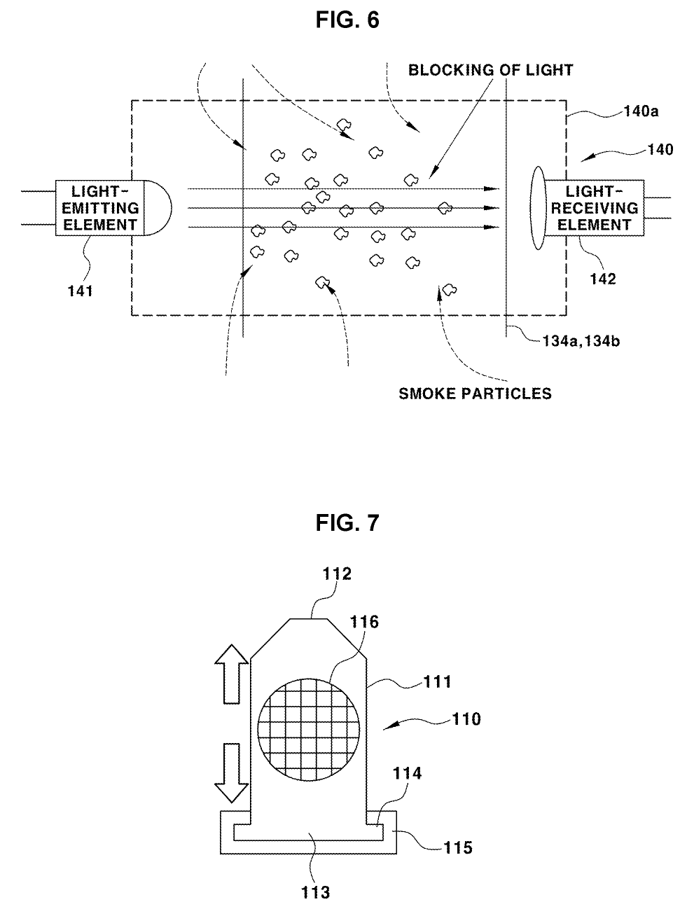

FIG. 6 is a diagram showing a photoelectric smoke detector having a light-emitting element and a light-receiving element according to an embodiment of the present disclosure.

In the present disclosure, the smoke detector 140 may include a housing 140a (in FIG. 6) that is provided to surround the periphery of the smoke detection pipes 134a and 134b so that the smoke detection pipe passes therethrough, and a smoke detection sensor that is provided in the housing 140a to detect smoke passing through the smoke detection pipes and outputs an electrical signal according to the detection result.

In an embodiment of the present disclosure, the smoke detection sensor may be a photoelectric sensor, and the smoke detector 140 may be a photoelectric smoke detector. The photoelectric sensor uses the principle that smoke particles block or reflect light, and may be configured to include a light-emitting element 141 and a light-receiving element 142.

As shown in FIG. 6, the photoelectric sensor may include the light-emitting element 141 provided on one side of the housing 140a with reference to the smoke detection pipes 134a and 134b, and the light-receiving element 142 provided on the other side of the housing 140a opposite the light-emitting element 141 with reference to the smoke detection pipes 134a and 134b to convert light received from the light-emitting element 141 through the smoke detection pipes 134a and 134b into an electrical signal and output the result.

The light-receiving element 142 is provided to output an electrical signal according to the concentration of smoke particles contained in the air. The electrical signal output from the light-receiving element 142 is input to the controller 101, and the controller 101 is configured to determine whether fire occurs on the basis of the electrical signal received from the light-receiving element 142.

The controller 101 may determine the concentration of smoke particles in the air passed through the smoke detection pipes 134a and 134b in the housing 140a of the smoke detector 140 on the basis of the electrical signal received from the smoke detector 140, and then determine whether fire occurs on the basis of the concentration of the smoke particles. The controller 101 may be configured to determine that fire occurs in a case where the concentration of smoke particles is equal to or greater than a set value.

In the smoke detector 140, since the light emitted from the light-emitting element 141and passed through the smoke detection pipes 134a and 134b should be received by the light-receiving element 142, it is preferable that a section of the smoke detection pipes 134a and 134b located inside the housing 140a, that is, a section in which at least the light from the light-emitting element 141 passes through the light-receiving element 142 is made of a transparent material that allows light to pass therethrough.

In the smoke detector 140 of the fire extinguishing system 100 according to the present disclosure, the pair of light-emitting element 141 and light-receiving element 142 may be provided for each of the two smoke detection pipes 134a and 134b.

That is, the smoke detection sensor is provided for each of the PE compartment-side smoke detection pipe 134a and the battery compartment-side smoke detection pipe 134b, and in a case where the light-emitting element 141 and the light-receiving element 142 are provided for each of the smoke detection pipe 134a and 134b, it is possible to identify the fire response space where fire actually occurs from the electrical signal output from each light-receiving element 142.

Alternatively, one light-emitting element 141 and a plurality of the light-receiving elements 142 may be provided so that light emitted from one light-emitting element 141 passes through both smoke detection pipes 134a and 134b and is received through each light-receiving element 142, and thus, it is possible to identify the fire response space where fire occurs on the basis of the electrical signal of the individual light-receiving elements 142.

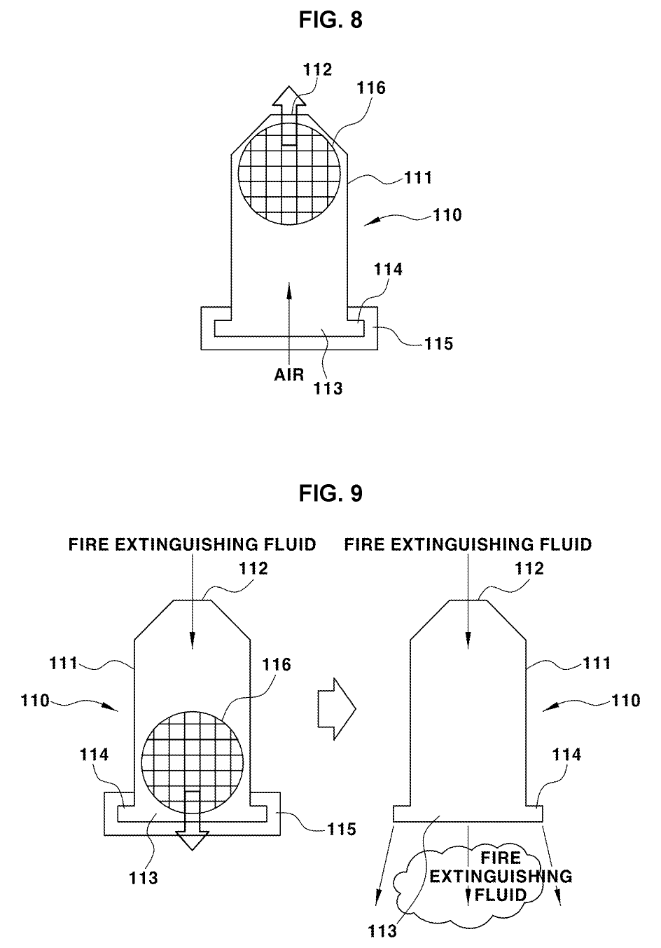

FIG. 7 is a diagram showing a configuration of a nozzle provided in a smoke suctioning and fire extinguishing fluid discharge pipe according to an embodiment of the present disclosure, FIG. 8 is a diagram showing an operating state of the nozzle in a fire detection mode according to an embodiment of the present disclosure, and FIG. 9 is a diagram showing an operating state of the nozzle when spraying a fire extinguishing fluid according to an embodiment of the present disclosure.

The nozzle 110 is fixedly provided in each of the smoke suctioning and fire extinguishing fluid discharge pipes 102a and 102b in the PE compartment 2 and the battery compartment 3, which are fire response spaces, and is used for two purposes in the present disclosure, that is, smoke suctioning and fire extinguishing fluid spraying.

In the embodiment of the present disclosure, the nozzle 110 may be equipped with filter members 115 and 116 capable of removing fine dust from air or air and smoke suctioned through the nozzle 110 and the smoke-suctioning and extinguishing fluid discharge pipes 102a and 102b in the fire detection mode.

In a case where there are no filter members 115 and 116 to remove fine dust inside the nozzle when smoke is suctioned through the nozzle 110 in the fire detection mode, the performance of the smoke detector 140 may deteriorate due to the fine dust suctioned together with the smoke, thereby lowering the fire detection performance.

On the other hand, in spraying the fire extinguishing fluid through the nozzle 110, in a case where the filter members 115 and 116 are provided inside the nozzle, the filter members may block the passage of the fire extinguishing fluid inside the nozzle or interfere with the passage of the fire extinguishing fluid, which may lower the fire extinguishing fluid spraying performance.

Therefore, in the fire detection mode where air (or air containing smoke) is normally suctioned through the nozzle, the filter members 115 and 116 should be normally provided inside the nozzle 110, and in spraying the fire extinguishing fluid, it is necessary to ensure that the filter members 115 and 116 are easily separated from the nozzle 110 by the sprayed fire extinguishing fluid.

Referring to FIG. 7, the nozzle 110 may be configured to include a nozzle pipe 111 having a first end portion 112 connected to communicate with the inside of the smoke suctioning and fire extinguishing fluid discharge pipes 102a and 102b (FIG. 5) and a second end portion 113 on the opposite side disposed to face a device or component with a risk of fire within the PE compartment 2 or the battery compartment 3, which is the fire response space; a first filter member 115 that is detachably provided to cover the second end portion 113 of the nozzle pipe 111 and primarily removes fine dust; and a second filter member 116 that is provided inside the nozzle pipe 111, is provided to move back and forth (in an up-down direction in the figure) toward the first end portion 112 and the second end portion 113, and secondarily removes fine dust.

In the nozzle 110 having the above-mentioned configuration, the first end portion 112 is a portion connected to the smoke suctioning and fire extinguishing fluid discharge pipe 102a or 102b, and is configured so that a cross-sectional area of the portion directly connected to the smoke suctioning and fire extinguishing fluid discharge pipe 102a or 102b is smaller than a cross-sectional area of the nozzle pipe 111.

For example, as shown in FIG. 7, the first end portion 112 may have a pipe shape in which the cross-sectional area gradually decreases from the nozzle pipe 111 to the portion connected to the smoke suctioning and fire extinguishing fluid discharge pipe (102a and 102b in FIG. 5).

In an embodiment of the present disclosure, the first filter member 115 may be a mesh net (e.g., wire mesh) having a relatively large mesh size, and may be provided at the second end portion 113 of the nozzle pipe 111 so as to be detached by the fire extinguishing fluid sprayed in fire suppression.

That is, the first filter member 115 is provided transversely at the second end portion 113, which is an outlet part of the fire extinguishing fluid of the nozzle pipe 111 and a suction part of air (or air containing smoke), and is coupled to an outer position of the nozzle pipe 111 so as to be detached from the second end portion 113 by the fire extinguishing fluid having passed through the inside of the nozzle pipe 111 for fire suppression.

Here, a flange portion 114 having an outwardly extended shape is formed on the second end portion 113 of the nozzle pipe 111, and the first filter member 115 may be fixedly combined so that an edge portion of the first filter member 115 surrounds the flange portion 114 while being horizontally disposed on the second end portion 113 of the nozzle pipe 111.

In an embodiment of the present disclosure, the second filter member 116 is provided between the first end portion 112 and the second end portion 113 inside the nozzle pipe 111, and removes foreign substances such as fine dust passed through the first filter member 115.

In an embodiment of the present disclosure, the second filter member 116 may be a ball-shaped member formed of a mesh structure. The ball-shaped secondary filter element 116 is provided to move freely in the space within the nozzle pipe 111 between the first end portion 112 and the second end portion 113.

In an embodiment of the present disclosure, the second filter member 116 may be a ball-shaped member having a mesh size smaller than that of the first filter member 115, and may be a member formed by bending or rolling a thin wire or the like in a ball shape.

The secondary filter element 116, similar to the primary filter element 115, is intended to maintain the performance of the smoke detector 140 by removing the foreign substances such as fine dust from the suctioned air, and also plays a role of detaching the primary filter element 115 when spraying the fire extinguishing fluid.

As shown in FIG. 8, in a case where air is suctioned through the suction pipe 144, the smoke detection pipe 134, and the smoke suctioning and fire extinguishing fluid discharge pipe 102a or 102b by the air compressor 128, the ball-shaped second filter member 116 is positioned on the side of the first end portion 112 connected to the smoke suctioning and fire extinguishing fluid discharge pipe 102a or 102b by the suction pressure within the nozzle pipe 111.

Here, the ball-shaped secondary filter element 116 is positioned to block the internal passage of the nozzle pipe 111, but allows air and smoke to pass therethrough due to its mesh structure, and removes fine dust from the air being suctioned in case of fire while allowing smoke and air to pass therethrough, thereby maintaining the performance of the smoke detector 140.

On the other hand, in a case where the fire extinguishing fluid is sprayed, as shown in FIG. 9, the fire extinguishing fluid supplied through the smoke suctioning and fire extinguishing fluid discharge pipe 102a or 102b passes through the inside of the nozzle pipe 111, and strongly pushes the ball-shaped second filter member 116.

Here, the second filter member 116 causes an impact while strongly pushing the first filter member 115 together with the fire extinguishing fluid, and thus, the first filter member 115 is detached from the second end portion 113, which is the outlet part of the fire extinguishing fluid of the nozzle pipe 111, by the second filter member 116. In a case where the primary filter element 115 is detached from the nozzle pipe 111, the secondary filter element 116 also comes out of the nozzle pipe 111 and is detached.

In this way, the second filter member 116 removes foreign substances and also detaches the first filter member 115 from the nozzle pipe 111. In spraying the fire extinguishing fluid, the second filter member 116 pushes the first filter member 115 outward to remove the first filter member 115, thereby maintaining a strong extinguishing fluid spray pressure at the nozzle 110.

The configuration of the fire extinguishing system according to the embodiment of the present disclosure has been described in detail, and an operating state of the fire extinguishing system will be described.

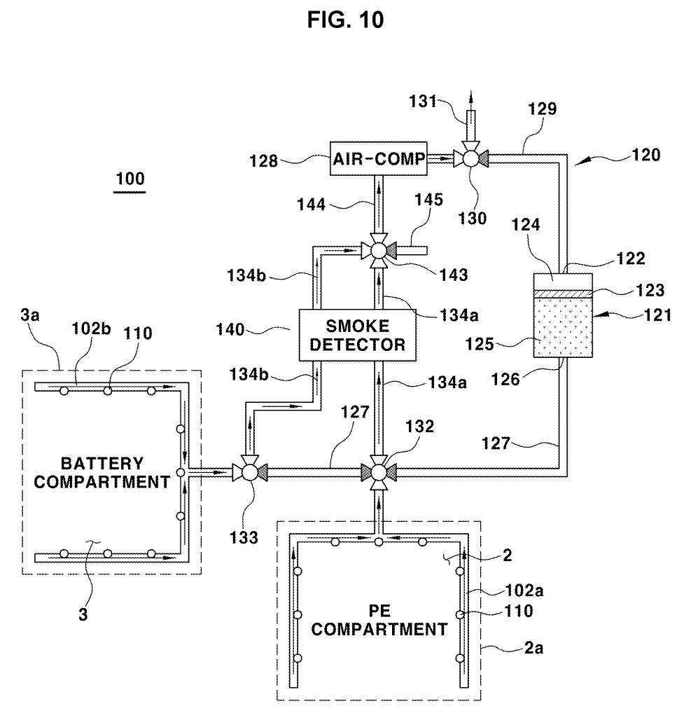

FIG. 10 is a drawing showing an operating state in the fire detection mode of the fire extinguishing system according to the embodiment of the present disclosure. In order to detect fire in normal times, the air compressor 128 is operated to apply suction pressure of the air compressor 128 to the PE compartment 2 and the battery compartment 3.

That is, the air compressor 128 is operated, and the first valve 132 connects the smoke suctioning and fire extinguishing fluid discharge pipe 102a on the PE compartment-side and the smoke detection pipe 134a, under the control of the controller 101.

In addition, the second valve 133 connects the battery compartment-side smoke suctioning and fire extinguishing fluid discharge pipe 102b and the smoke detection pipe 134b, under the control of the controller 101. Here, the first valve 132 and the second valve 133 are controlled to block the fire extinguishing fluid supply pipe 127.

In addition, the third valve 143 is controlled to block the intake port 145 while allowing the PE compartment-side smoke detection pipe 134a and the battery compartment-side smoke detection pipe 134b to communicate with the suction pipe 144 connected to the inlet of the air compressor 128. The fourth valve 130 is controlled to open the exhaust port 131 while blocking a flow path of the air supply pipe 129 connected to the outlet of the air compressor 128.

Accordingly, in a case where the air compressor 128 is in operation, the suction pressure is applied to the PE compartment 2 and the battery compartment 3 through the suction pipe 144, the third valve 143, the smoke detection pipe 134a or 134b, the first valve 132, the second valve 133, and the smoke suctioning and fire extinguishing fluid discharge pipe 102a or 102b.

In a state where the suction pressure is applied, the air inside the PE compartment 2 and the battery compartment 3 passes through the smoke suctioning and fire extinguishing fluid discharge pipe 102a or 102b, the first valve 132, the second valve 133, the smoke detection pipe 134a or 134b, the third valve 143, the suction pipe 144, and the air compressor 128, and then is discharged into the atmosphere through the air supply pipe 129 and the exhaust port 131 of the fourth valve 130.

Here, in a case where fire breaks out inside the PE compartment 2 or the battery compartment 3, smoke generated by the fire is suctioned together with air from the space where the fire broke out, and the smoke moves together with the air through the smoke suctioning and fire extinguishing fluid discharge pipe 102a or 102b and the smoke detection pipe 134a or 134b, and passes through the smoke detector 140.

Accordingly, an electrical signal of the smoke detector 140 is input to the controller 101, and the controller 101 may detect the occurrence of the fire on the basis of the electrical signal of the smoke detector 140 and identify the space where the fire occurs.

In a case where air is suctioned, the air is suctioned through each nozzle 110 of the PE compartment-side smoke suctioning and fire extinguishing fluid discharge pipe 102a and the battery compartment-side smoke suctioning and fire extinguishing fluid discharge pipe 102b. In the PE compartment 2 where the fire occurs, smoke and air are suctioned together. Particularly, while air or air and smoke are suctioned through all the nozzles 110 provided in the smoke suctioning and fire extinguishing fluid discharge pipe 102a, fine dust is filtered and removed by the first filter member 115 and the second filter member 116.

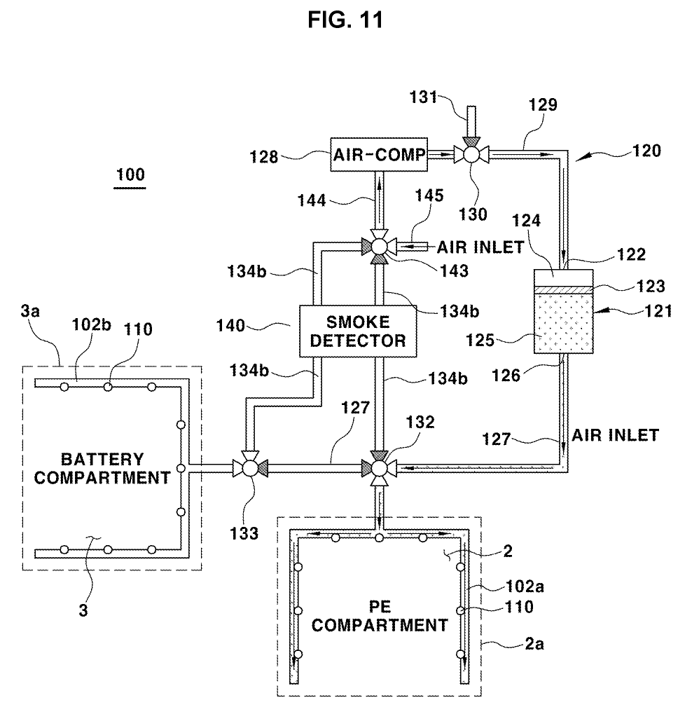

FIG. 11 is a diagram showing an operating state when fire is detected in the PE compartment of the fire extinguishing system according to the embodiment of the present disclosure. In a case where it is determined that fire occurs in the PE compartment 2, the air compressor 128 is operated under the control of the controller 101, and at this time, the third valve 143 is controlled to open the intake port 145 while blocking the flow path of the smoke detection pipe 134a or 134b.

In addition, the fourth valve 130 is controlled by the controller 101 to open the flow path of the air supply pipe 129 while blocking the exhaust port 131, and the first valve 132 is controlled to connect the fire extinguishing fluid supply pipe 127 and the smoke suctioning and fire extinguishing fluid discharge pipe 102a on the PE compartment-side while blocking the fire extinguishing fluid supply pipe 127 connected to the smoke detection pipe 134a and the second valve 133. Further, the second valve 133 is controlled to block a flow path of the fire extinguishing fluid supply pipe 127.

As a result, the suction pressure of the air compressor 128 acts on the suction pipe 144 and the third valve 143, thereby causing external air to flow in through the intake port 145, and the inflow air is suctioned into the air compressor 128 through the suction pipe 144 from the third valve 143 and then discharged through the air supply pipe 129.

Here, the high-pressure compressed air discharged from the air compressor 128 may be supplied to the fire extinguishing fluid tank 121 through the fourth valve 130 and the air supply pipe 129, and then be supplied into the pressure chamber 124 of the fire extinguishing fluid tank 121 through the air inlet port 122.

Then, the pressure transfer plate 123 is pushed forward by the pressure of the compressed air supplied to the pressure chamber 124 of the fire extinguishing fluid tank 121, thereby pressurizing the fire extinguishing fluid filled in the fire extinguishing fluid chamber 125 of the fire extinguishing fluid tank 121, and the fire extinguishing fluid inside the fire extinguishing fluid chamber 125 is pressurized by the pressure transfer plate 123 and discharged through the fire extinguishing fluid outlet 126 of the fire extinguishing fluid tank 121 into the fire extinguishing fluid supply pipe 127.

Accordingly, the fire extinguishing fluid passed through the fire extinguishing fluid supply pipe 127 moves along the PE compartment-side smoke suctioning and fire extinguishing fluid discharge pipe 102a from the first valve 132, and is then sprayed into the PE compartment 2 through the nozzle 110, thereby suppressing the fire that occurs in the PE compartment 2 by the sprayed fire extinguishing fluid.

In the smoke suctioning and fire extinguishing fluid discharge pipe 102a, the fire extinguishing fluid may be evenly sprayed into the PE compartment 2 through all the nozzles 110, and when the fire extinguishing fluid is sprayed, as described above, since the first filter member 115 and the second filter member 116 are detached from the nozzle pipe 111 by the fire extinguishing fluid, the fire extinguishing fluid may be smoothly sprayed through each nozzle 110.

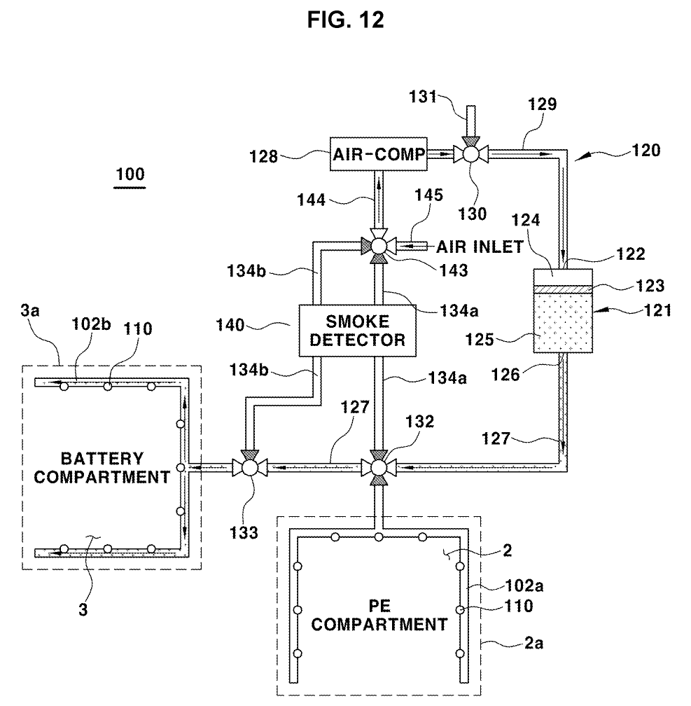

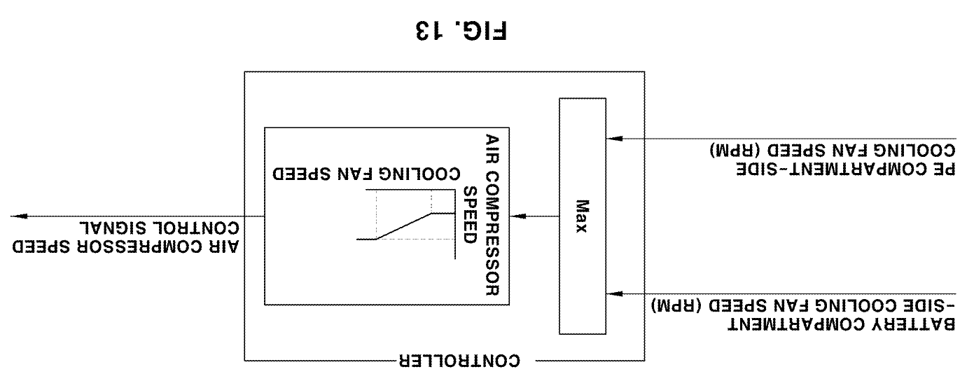

FIG. 12 is a diagram showing an operating state in a case where fire is detected in a battery compartment of the fire extinguishing system according to the embodiment of the present disclosure. In a case where it is determined that fire occurs in the battery compartment 3, the air compressor 128 is operated under the control of the controller 101, and at this time, the third valve 143 and the fourth valve 130 are controlled in the same manner as when fire is detected in the PE compartment.

However, the first valve 132 is controlled by the controller 101 to block the flow paths of the smoke detection pipe 134a and the PE compartment-side smoke suctioning and fire extinguishing fluid discharge pipe 102a while opening the flow path of the fire extinguishing fluid supply pipe 127, and the second valve 133 is controlled to block the flow path of the smoke detection pipe 134b while allowing the fire extinguishing fluid supply pipe 127 and the battery compartment-side smoke suctioning and fire extinguishing fluid discharge pipe 102b to communicate with each other.

As a result, the suction pressure of the air compressor 128 acts on the suction pipe 144 and the third valve 143, thereby causing external air to flow in through the intake port 145, and the inflow air is suctioned into the air compressor 128 through the suction pipe 144 from the third valve 143 and then discharged through the air supply pipe 129.

Here, the high-pressure compressed air discharged from the air compressor 128 may be supplied to the fire extinguishing fluid tank 121 through the fourth valve 130 and the air supply pipe 129, and then supplied into the pressure chamber 124 of the fire extinguishing fluid tank 121 through the air inlet port 122.

Then, the pressure transfer plate 123 is pushed forward by the pressure of the compressed air supplied to the pressure chamber 124 of the fire extinguishing fluid tank 121, thereby pressurizing the fire extinguishing fluid filled in the fire extinguishing fluid chamber 125 of the fire extinguishing fluid tank 121, and the fire extinguishing fluid inside the fire extinguishing fluid tank 121 is pressurized by the pressure transfer plate 123 and discharged through the fire extinguishing fluid outlet 126 of the fire extinguishing fluid tank 121 to the fire extinguishing fluid supply pipe 127.

Accordingly, the fire extinguishing fluid having passed through the fire extinguishing fluid supply pipe 127 passes through the first valve 132, moves through the second valve 133 to the battery compartment-side smoke suctioning and fire extinguishing fluid discharge pipe 102b, and then is sprayed into the battery compartment 3 through the nozzle 110 from the battery compartment-side smoke suctioning and fire extinguishing fluid discharge pipe 102b. Accordingly, it is possible to extinguish the fire that occurs in the battery compartment 3 by the sprayed fire extinguishing fluid.

In the smoke suctioning and fire extinguishing fluid discharge pipe 102b, the fire extinguishing fluid may be evenly sprayed into the battery compartment 3 through the nozzles 110, and when the fire extinguishing fluid is sprayed, as described above, the first filter member 115 and the second filter member 116 are detached from the nozzle pipe 111 by the fire extinguishing fluid, so that the fire extinguishing fluid can be smoothly sprayed through each nozzle 110.

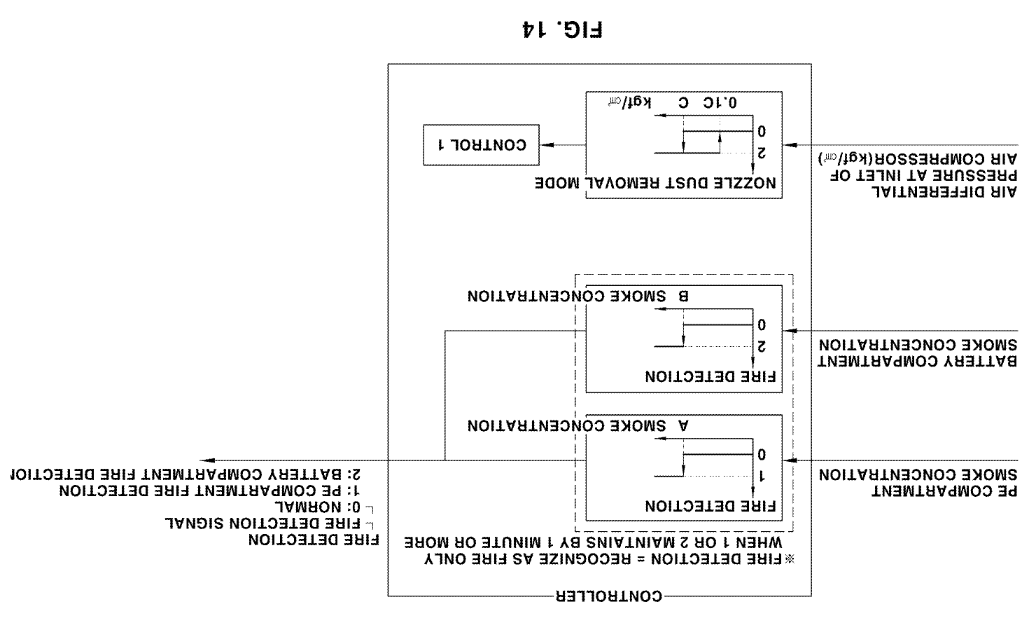

FIG. 13 is a diagram for illustrating a method of controlling an air compressor by a controller of the fire extinguishing system according to the embodiment of the present disclosure.

In the fire detection mode, the speed (RPM) of the air compressor 128 is controlled to vary on the basis of the speed (RPM) of the PE compartment-side cooling fan (electric fan) and the speed (RPM) of the battery compartment-side cooling fan 9 (electric fan, in FIG. 4).

That is, the controller 101 determines the speed of the air compressor 128 corresponding to the larger value between the speed of the PE compartment-side cooling fan and the speed of the battery compartment-side cooling fan 9 from setting data such as a map, and then controls the speed of the air compressor 128 at the determined speed.

In an embodiment of the present disclosure, in order to determine the speed of the air compressor corresponding to the speed of the cooling fan, the controller may pre-store the setting data that defines the correlation between the speed of the cooling fan and the speed of the air compressor.

As described above, the cooling fan that supplies air to a radiator, etc., among the devices constituting the cooling module, may be provided inside the PE compartment 2 and the battery compartment 3, and the cooling fan suctions outside air and blows the air into the inside of the PE compartment 2 and the battery compartment 3. Accordingly, in a case where the cooling fan is operated, forced convection of air occurs inside the PE compartment 2 and the battery compartment 3.

In a case where the forced convection of the air occurs by the cooling fan inside the PE compartment 2 and the battery compartment 3, the air moves strongly in one direction, and the smoke generated inside the PE compartment 2 and the battery compartment 3 also moves along with the forced convection air.

The smoke detector 140 should be able to detect fire by detecting smoke in case of fire. However, in a case where fire occurs at the time when the cooling fan is in operation, the smoke caused by the fire may not be properly suctioned through the smoke suctioning and fire extinguishing fluid discharge pipes 102a and 102b and the nozzle 110 located inside the PE compartment 2 and the battery compartment 3 due to the air blown by the cooling fan. For this reason, there is a high possibility that the smoke may not reach the location of the smoke detector 140, which may make it difficult to detect fire in time.

Accordingly, in order to suction the smoke by the suction pressure of the air compressor 128, considering that the faster the speed of the cooling fan 9 (FIG. 4), the greater the amount and speed of the forced convection air, and the higher the possibility that smoke caused by fire will move together with the air, it is necessary to make the speed of the air compressor higher in consideration of the speed of the cooling fan to increase the suction pressure applied to the PE compartment 2 and the battery compartment 3 through the smoke suctioning and fire extinguishing fluid discharge pipes 102a and 102b and the nozzle 110.

In a case where a large suction pressure is applied to the PE compartment 2 and the battery compartment 3 as described above, the smoke suctioned through the fire extinguishing fluid discharge pipes 102a and 102b, the nozzle 110, and the smoke detection pipes 134a and 134b may properly enter the smoke detector 140 at the same time when fire occurs, and as a result, the fire occurring in the PE compartment 2 and the battery compartment 3 may be detected in time by the smoke detector 140.

Accordingly, it is necessary to control the operation of the air compressor at a speed corresponding to the speed of the cooling fan, and in order to make the cooling fan speed faster as the suction pressure becomes higher, it is also necessary to control the speed of the air compressor at a faster speed.

In consideration of the above description, a speed value of the air compressor is preset in the setting data of the controller 101 as a value corresponding to the speed of the cooling fan, and the speed (target speed) of the air compressor in the setting data may be set to a larger value as the speed of the cooling fan increases.

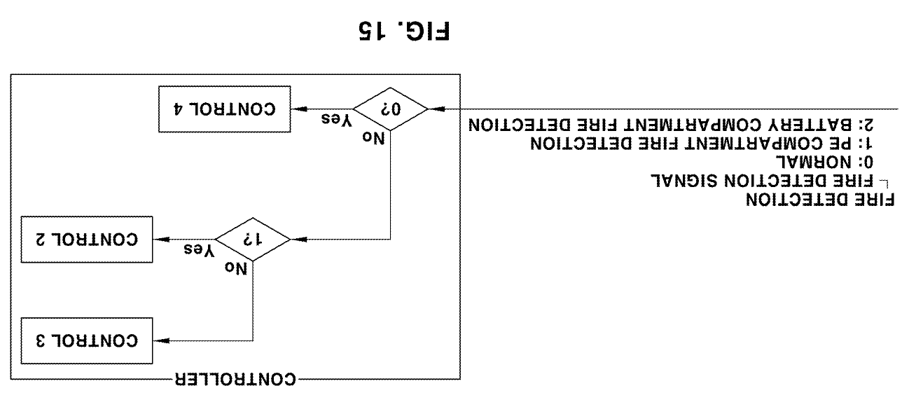

FIG. 14 is a diagram for illustrating a method of detecting fire by the controller of the fire extinguishing system according to the embodiment of the present disclosure. In the fire detection mode shown in FIG. 10, in a case where it is determined that fire occurs from an electrical signal of the smoke detector 140, the controller 101 generates a fire detection signal according to the determination result.

In the smoke detector 140, an electrical signal output from the smoke detection sensor on the PE compartment side is a signal corresponding to the concentration of smoke in the air suctioned in the PE compartment 2, and an electrical signal output from the smoke detection sensor on the battery compartment side is a signal corresponding to the concentration of smoke in the air suctioned in the battery compartment 3. The electrical signals output from the PE compartment-side smoke detection sensor and the battery compartment-side smoke detection sensor are signals indicating the concentrations of smoke flowing out of the respective fire response spaces.

The controller 101 determines the PE compartment-side smoke concentration and the battery compartment-side smoke concentration from the electrical signals output from the respective smoke detection sensors, compares the PE compartment-side smoke concentration and the battery compartment-side smoke concentration with preset reference values A and B, and determines that fire occurs in the corresponding space in a case where either the PE compartment-side smoke concentration or the battery compartment-side smoke concentration is equal to or higher than each reference value for a preset period of time or longer.

According to the embodiment of FIG. 14, in a case where the PE compartment-side smoke concentration is maintained at the value A or higher, which is the reference value, for a preset time (e.g., 1 minute), the controller 101 determines that there is fire in the PE compartment 2, and generates a fire detection signal (signal value “1”) indicating that fire occurs in the PE compartment 2.

In a case where the battery compartment-side smoke concentration remains at the reference value B or higher for a preset period of time, the controller 101 determines that there is fire in the battery compartment 3, and generates a fire detection signal (signal value “2”) indicating that fire occurs in the battery compartment 3. Here, in a case where a normal state with no fire is maintained, the controller 101 may generate a signal (signal value “0”) indicating the normal state.

In addition, the air compressor 128 is provided with a standard pressure sensor that detects the pressure at the inlet (suction side) thereof, that is, an air differential pressure, and the pressure sensor is provided to transmit a signal to the controller 101.

The electrical signal output from the pressure sensor is a signal corresponding to the air pressure applied to the inlet of the air compressor 128, and the controller 101 receives the electrical signal output from the pressure sensor.

In the present disclosure, the controller 101 may be set to periodically perform a nozzle dust removal mode. In the nozzle dust removal mode, the controller 101 determines, in a state where the air compressor 128 is operated to apply suction pressure to each fire response space, whether a certain level of dust is accumulated in the nozzle 110 of the smoke suctioning and fire extinguishing fluid discharge pipe 102a or 102b provided in each fire response space.

Here, the controller 101 determines the air differential pressure, which is the pressure at the inlet of the air compressor 128, on the basis of the electrical signal input from the pressure sensor while the air compressor is operating. In a case where the air differential pressure detected by the pressure sensor is equal to or higher than a first set pressure (an upper threshold “C”), it is determined that a certain level of dust has accumulated in the nozzle 110 of the smoke suctioning and fire extinguishing fluid discharge pipe 102a or 102b provided in each fire response space.

In a case where it is determined that the certain level of dust has accumulated, the controller 101 performs control for nozzle reverse cleaning (“control 1” in FIG. 14). To this end, the controller 101 operates the air compressor 128 in the reverse direction at a set speed (e.g., -3000 RPM), and controls the opening states of the first valve 132, the second valve 133, the third valve 143, and the fourth valve 130 in the same manner as in the fire detection mode.

As a result, the high-pressure compressed air discharged in the reverse direction from the inlet of the air compressor 128 moves in the reverse direction to that in fire detection and is supplied to the PE compartment-side smoke suctioning and fire extinguishing fluid discharge pipe 102a and the battery compartment-side smoke suctioning and fire extinguishing fluid discharge pipe 102b.

Thus, reverse cleaning may be performed to remove the dust accumulated in each nozzle 110 by discharging the high-pressure compressed air through each nozzle 110 from the smoke suctioning and fire extinguishing fluid discharge pipe 102a or 102b in each fire response space of the PE compartment 2 and the battery compartment 3.

During the reverse cleaning, the operation of the air compressor 128 is maintained until the air differential pressure at the inlet of the air compressor detected by the pressure sensor reaches a second set pressure (lower threshold “0.1C”), and in a case where the second set pressure is reached, the operation of the air compressor 128 is stopped.

FIG. 15 is a diagram for illustrating a control state in fire detection of the fire extinguishing system according to the embodiment of the present disclosure.

In a case where it is determined that fire occurs in the PE compartment 2, that is, in a case where the controller 101 generates a fire detection signal with a signal value of “1”, the controller 101 controls the opening states of the first valve 132, the second valve 133, the third valve 143, and the fourth valve 130 as shown in FIG. 11, and operates the air compressor 128 (“control 2” in FIG. 15). Here, the air compressor 128 may be operated at the maximum speed.

This allows the fire extinguishing fluid filled in the fire extinguishing fluid tank 121 to be supplied to the PE compartment-side smoke suctioning and fire extinguishing fluid discharge pipe 102a, and thus, allows the fire extinguishing fluid to be sprayed into the PE compartment 2 through each nozzle 110 from the PE compartment-side smoke suctioning and fire extinguishing fluid discharge pipe 102a, thereby extinguishing the fire in the PE compartment.

Further, in a case where the controller 101 generates the fire detection signal “1”, the controller 101 operates a warning device (not shown) of the vehicle 1 according to the fire detection signal to notify a driver of the fire occurrence and the status of fire extinguishing fluid spraying in the PE compartment 2, and also wirelessly transmits a fire occurrence signal to a nearby fire station for dispatch of a fire truck.

In a case where the controller 101 determines that fire occurs in the battery compartment 3, that is, in a case where the controller 101 generates a fire detection signal with a signal value of “2”, as shown in FIG. 12, the controller 101 controls the opening states of the first valve 132, the second valve 133, the third valve 143, and the fourth valve 130, and operates the air compressor 128 (“control 3” in FIG. 15). Here, the air compressor 128 may be operated at the maximum speed.

This allows the fire extinguishing fluid filled in the fire extinguishing fluid tank 121 to be supplied to the smoke suctioning and fire extinguishing fluid discharge pipe 102b of the battery compartment 3, and thus, allows the fire extinguishing fluid to be sprayed into the battery compartment 3 through each nozzle 110 from the battery compartment-side smoke suctioning and fire extinguishing fluid discharge pipe 102b, thereby extinguishing the fire in the battery compartment.

Further, in a case where the controller 101 generates the fire detection signal “2”, the controller 101 operates the warning device of the vehicle 1 according to the fire detection signal to notify the driver of the fire occurrence and the status of fire extinguishing fluid spraying in the battery compartment 3, and also wirelessly transmits a fire occurrence signal to a nearby fire station for dispatch of a fire truck.

In a case where the fire response space is in a normal state where no fire occurs, the controller 101 controls the fire extinguishing system 100 of the present disclosure to the normal fire detection mode described with reference to FIG. 10 (“control 4” in FIG. 15).

According to the fire extinguishing system for the vehicle according to the present disclosure, it is possible to accurately detect fire occurring in a vehicle, and quickly and automatically extinguish the fire.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A fire extinguishing system for a vehicle comprising:
a smoke suctioning and fire extinguishing fluid discharge pipe provided in a fire response space and includes a nozzle for spraying a fire-extinguishing fluid;
a smoke detection pipe connected to the smoke suctioning and fire extinguishing fluid discharge pipe through a valve;
an air compressor configured to apply suction pressure to the smoke detection pipe;
a smoke detector configured to detect smoke suctioned through the nozzle by the suction pressure of the air compressor acting on the smoke suctioning and fire extinguishing fluid discharge pipe through the smoke detection pipe;
a controller configured to output, when smoke is detected through the smoke detector, a control signal to supply the fire extinguishing fluid to the smoke suctioning and fire extinguishing fluid discharge pipe so that the fire extinguishing fluid is sprayed through the nozzle into the fire response space; and
a fire extinguishing fluid supply device configured to supply the fire extinguishing fluid to the smoke suctioning and fire extinguishing fluid discharge pipe according to the control signal output from the controller.

2. The system according to claim 1, wherein the fire response space includes a plurality of the fire response spaces, and the smoke suctioning and fire extinguishing fluid discharge pipe is provided in each of the plurality of fire response spaces.

3. The system according to claim 2, wherein the plurality of fire response spaces includes one or both of:
a PE compartment having power electric (PE) parts; and
a battery compartment having a battery.

4. The system according to claim 1, wherein the fire response space comprises a PE compartment having power electric (PE) parts, and a battery compartment having a battery, and the smoke suctioning and fire extinguishing fluid discharge pipe for spraying the fire extinguishing fluid to the power electronic parts or the battery through the nozzle comprises a first smoke suctioning and fire extinguishing fluid discharge pipe provided in the PE compartment and a second smoke suctioning and fire extinguishing fluid discharge pipe provided in the battery compartment.

5. The system according to claim 4, wherein, when the suction pressure of the air compressor is applied to the smoke suctioning and fire extinguishing fluid discharge pipe provided in the PE compartment and the smoke suctioning and fire extinguishing fluid discharge pipe provided in the battery compartment through the smoke detection pipe, the controller is configured to control the air compressor to operate at a speed corresponding to a speed of a cooling fan provided in the PE compartment or a speed of a cooling fan provided in the battery compartment.

6. The system according to claim 5, wherein the controller is configured to determine the speed of the air compressor as a larger value between the speed of the cooling fan provided in the PE compartment and the speed of the cooling fan provided in the battery compartment, and determines the speed of the air compressor as a larger value as the speed of the cooling fan becomes higher.

7. The system according to claim 4, wherein a first fire extinguishing fluid supply pipe that supplies the fire extinguishing fluid from the fire extinguishing fluid supply device is extended to the PE compartment and a second fire extinguishing fluid supply pipe that supplies the fire extinguishing fluid from the fire extinguishing fluid supply device is extended to the battery compartment, and the smoke suctioning and fire extinguishing fluid discharge pipe is connected to the fire extinguishing fluid supply pipe through the valve to communicate with the fire extinguishing fluid supply pipe.

8. The system according to claim 7, wherein the valve comprises a first valve and a second valve, and wherein, in the middle of the fire extinguishing fluid supply pipe, the first smoke suctioning and fire extinguishing fluid discharge pipe and the first smoke detection pipe are connected through the first valve having an opening state controlled by the controller, and, at an end of the fire extinguishing fluid supply pipe, the second smoke suctioning and fire extinguishing fluid discharge pipe and the second smoke detection pipe are connected through the second valve having an opening state controlled by the controller.

9. The system according to claim 8, wherein the first smoke detection pipe connected to the first smoke suctioning and fire extinguishing fluid discharge pipe provided in the PE compartment through the first valve and the second smoke detection pipe connected to the second smoke suctioning and fire extinguishing fluid discharge pipe provided in the battery compartment through the second valve are connected through a third valve after passing through the smoke detector, and the first smoke detection pipe, the second smoke detection pipe, and a suction pipe connected to an inlet of the air compressor are connected through the third valve having an opening state controlled by the controller.

10. The system according to claim 7, wherein the fire extinguishing fluid supply device comprises:
a fire extinguishing fluid tank in which the fire extinguishing fluid is stored; and
a pressure transfer plate that is moved by pressure of a working fluid supplied to a pressure chamber of the fire extinguishing fluid tank and pressurizes the fire extinguishing fluid filled in a fire extinguishing fluid chamber of the fire extinguishing fluid tank to discharge the fire extinguishing fluid from the fire extinguishing fluid tank to the fire extinguishing fluid supply pipe.

11. The system according to claim 10, wherein the working fluid is compressed air supplied by the air compressor.

12. The system according to claim 11, wherein the first smoke detection pipe connected to the first smoke suctioning and fire extinguishing fluid discharge pipe provided in the PE compartment through the valve, and the second smoke detection pipe connected to the second smoke suctioning and fire extinguishing fluid discharge pipe provided in the battery compartment through the valve are connected through a third valve after passing through the smoke detector, and the first smoke detection pipe, the second smoke detection pipe, an intake port connected to an atmosphere, and a suction pipe connected to an inlet of the air compressor are connected through the third valve, which comprises a 4-way valve having an opening state controlled by the controller.

13. The system according to claim 11, wherein a fourth valve comprising a 3-way valve having an opening state controlled by the controller, is provided at a location where an exhaust port branches off in the middle of an air supply pipe connected to the pressure chamber of the fire extinguishing fluid tank to supply compressed air from the air compressor.

14. The system according to claim 1, wherein the nozzle comprises:
a nozzle pipe having a first end portion connected to the smoke suctioning and fire extinguishing fluid discharge pipe and a second end portion through which air or air and smoke inside the fire response space is suctioned or the fire extinguishing fluid is discharged and sprayed; and
a filter member provided in the nozzle pipe configured to remove foreign substances in the air or air and smoke suctioned through the second end portion of the nozzle pipe by the suction pressure of the air compressor.

15. The system according to claim 14, wherein the filter member comprises:
a first filter member positioned at the second end portion of the nozzle pipe configured to remove foreign substances; and
a second filter member positioned on an inside the nozzle pipe and configured to remove foreign substances having passed through the first filter member.

16. The system according to claim 15, wherein the first filter member is detachably connected to the second end portion of the nozzle pipe, the second filter member is movably provided in a space between the first end portion and the second end portion inside the nozzle pipe, and the first and second filter members, when the second filter member is moved by the fire extinguishing fluid passing through the inside of the nozzle pipe and impacts the first filter member in spraying the fire extinguishing fluid, are configured to be detached from the nozzle pipe.

17. The system according to claim 16, wherein the second filter member is a ball-shaped member made of a mesh structure through which the air or air and smoke passes.
